(19) United States
(12) Patent Application Publication
(10) Pub. No.: US 2026/0253606 A1
(43) Pub. Date: Aug. 27, 2026

(54) NEURAL AUDIO QUALITY ESTIMATION BASED ON NORMALIZED QUANTIZATION ERROR

(71) Applicants: Fraunhofer-Gesellschaft zur Foerderung der angewandten Forschung e.V., München (DE); Friedrich-Alexander-Universitaet Erlangen-Nuernberg, in Vertretung des Freistaates Bayern, Erlangen (DE)

(72) Inventors: Mohammed Modar HALIMEH, Erlangen (DE); Emanuel A.P. HABETS, Erlangen (DE); Matteo TORCOLI, Erlangen (DE); Philipp GRUNDHUBER, Erlangen (DE); Harald FUCHS, Erlangen (DE); Yannik GREWE, Erlangen (DE)

(73) Assignees: Fraunhofer-Gesellschaft zur Foerderung der angewandten Forschung e.V., München (DE); Friedrich-Alexander-Universitaet Erlangen-Nuernberg, in Vertretung des Freistaates Bayern, Erlangen (DE)

(21) Appl. No.: 19/065,563

(22) Filed: Feb. 27, 2025

(51) Int. Cl. G10L 25/69; G10L 19/038; G10L 25/30

(52) U.S. Cl. CPC G10L 25/69; G10L 19/038; G10L 25/30

(57) ABSTRACT

A deep neural audio quality estimation module includes a deep neural encoder, a vector quantizer, and a quality calculation module. The quality calculation module estimating the audio quality of an audio signal based on a normalized quantization error of the vector quantizer for the audio signal.

### FIELD OF THE INVENTION

Various examples of the disclosure generally pertain to audio quality estimation. Various examples specifically relate to an encoder neural network and a vector quantization operation used for audio quality estimation.

### BACKGROUND OF THE INVENTION

Estimation of an audio quality is a challenging task that has been often addressed by means of psychoacoustic modeling, see, e.g.,
P. Pocta and J. Beerends, “Subjective and objective assessment of perceived audio quality of current digital audio broadcasting systems and web-casting applications,” IEEE Transactions on Broadcasting, vol. 61, no. 3, pp. 407-415, 2015 or
Rix, Antony W., et al. “Perceptual evaluation of speech quality (PESQ)—a new method for speech quality assessment of telephone networks and codecs.” 2001 IEEE international conference on acoustics, speech, and signal processing. Proceedings (Cat. No. 01CH37221). Vol. 2. IEEE, 2001 or
Taal, Cees H., et al. “A short-time objective intelligibility measure for time-frequency weighted noisy speech.” 2010 IEEE international conference on acoustics, speech and signal processing. IEEE, 2010.

Such techniques that are based on psychoacoustic modeling face certain restrictions and drawbacks. For instance, such techniques are often computationally complex and cannot be executed in real-time. Accordingly, such techniques may not be applied for dynamically adaptive systems that provide the quality factor in real-time or quasi-real-time.

Audio quality estimation using functions trained using machine learning, e.g., deep neural networks, have been disclosed in Manocha, Pranay, et al. “A differentiable perceptual audio metric learned from just noticeable differences.” arXiv preprint arXiv:2001.04460 (2020). Here, it is proposed to train a neural network on a large-scale dataset of human judgments of just-noticeable differences, i.e., judging whether two recordings sound different or identical. The learned representation is then used to measure the distance between two audio signals as a proxy of quality. Ragano, Alessandro, Jan Skoglund, and Andrew Hines. “SCOREQ: Speech Quality Assessment with Contrastive Regression.” arXiv preprint arXiv:2410.06675 (2024) disclosed training a neural network which uses wav2vec2 (wav2vec 2.0: A framework for self-supervised learning of speech representations.” Advances in neural information processing systems 33 (2020): 12449-12460) embedding as input. The training uses a triplet loss function which separates signals based on their quality level as judged by a human listener. Such an approach has the disadvantage that it is required to acquire human annotations; the labeling process is error-prone and time-consuming. Furthermore, the accuracy of such estimation of the audio signal quality is relatively limited and strongly depends on the scale of the annotator.

Fu, Szu-Wei, et al. “Self-Supervised Speech Quality Estimation and Enhancement Using Only Clean Speech.” arXiv preprint arXiv: 2402.16321 (2024) proposes to train a neural codec on clean-speech signals only. Then, the quantization error energy is used directly as a proxy for speech signal quality. Such an approach requires a specific training strategy limited to clean-speech signals to provide reliable outputs.

Music quality is evaluated in Gui, Azalea, et al. “Adapting frechet audio distance for generative music evaluation.” ICASSP 2024-2024 IEEE International Conference on Acoustics, Speech and Signal Processing (ICASSP). IEEE, 2024. Here, Frechet audio distance is used as measured in a latent space between a reference set and a degraded signal. The latent space representations of both sets are extracted using pre-trained models such as Baevski, Alexei, et al. “wav2vec 2.0: A framework for self-supervised learning of speech representations.” Advances in neural information processing systems 33 (2020): 12449-12460.

### SUMMARY OF THE INVENTION

Accordingly, a need exists for advanced techniques of estimating the audio signal quality of an input audio waveform. A need exists for audio quality estimation that mitigates or alleviates at least some of the above-identified restrictions or drawbacks of prior art solutions.

Systems and methods are disclosed that enable estimating an audio signal quality using a pre-trained encoder and a vector quantizer, specifically residual vector quantizer. For instance, an encoder and a vector quantizer may be re-used from a neural audio codec, the audio code being also used to compress and subsequently decompress audio waveforms. Audio signal quality can be estimated non-intrusively, i.e., the quality of an audio signal may be estimated blindly without comparison between the degraded audio signal to a reference signal. Audio signal quality can be estimated intrusively, i.e., by processing a reference signal as well as a degraded signal and performing respective comparisons. The disclosed techniques enable various use cases, e.g., an encoder loop where the—e.g., intrusive—audio quality estimation is used to evaluate the quality of encoded signal at the encoder side. The encoded signal can be decoded for this purpose and then the quality of the decoded signal can be estimated using the techniques disclosed herein. Based on this quality benchmark, the encoder can be steered to achieve a certain quality level. In another use case, the audio quality estimation can be used at the decoder side. Here, a signal is obtained and encoded signal is obtained at the decoder and initially decoded. The quality is non-intrusively estimated and based on such audio quality estimation a postprocessing module—processing an output of the decoder—can be controlled, e.g., for signal enhancement, denoising, signal reconstruction. Thereby, the playback quality can be increased.

A method performed by one or more apparatuses is disclosed. The method includes obtaining an input audio waveform that comprises a sequence of audio samples. The method further includes using a pre-trained encoder neural network to generate, based on the input audio waveform, a sequence of feature vectors representing the sequence of audio samples using multiple features. The method also includes, for each feature vector of the sequence of feature vectors, determining a respective coded representation of the respective feature vector using vector quantization and further determining one or more indicators indicative of a respective quantization error associated with the respective coded representation of the respective feature vector. The method further includes, for each feature vector of the sequence of feature vectors, determining a respective quality factor based on one or more relationships between the one or more indicators indicative of the respective quantization error and one or more respective normalization values.

An apparatus is disclosed. The apparatus includes a processor and a memory, the process of being configured to load program code from the memory and to execute the program code, the processor, upon executing the program code, being configured to obtain an input audio waveform that comprises a sequence of audio samples. The processor, upon executing the program code, is further configured to use a pre-trained encoder neural network to generate, based on the input audio waveform, a sequence of feature vectors representing the sequence of audio samples using multiple features. The processor, upon executing the program code, is further configured to, for each feature vector of the sequence of feature vectors: determine a respective coded representation of the respective feature vector using vector quantization and further determine one or more indicators indicative of a respective quantization error associated with the respective coded representation of the respective feature vector. The processor, upon executing the program code, is further configured to, for each feature vector of the sequence of feature vectors: determine a respective quality factor based on one or more relationships between the one or more indicators indicative of the respective quantization error and one or more respective normalization values.

A method of training an audio quality estimation module is disclosed. The audio quality estimation module includes an encoder neural network for determining feature vectors based on input vectors, a vector quantizer for determining coded representations of the feature vectors, and a decoder neural network for decoding the coded representations of the feature vectors, thereby obtaining output vectors. The method includes adjusting weights of the encoder neural network, the vector quantizer, and the decoder neural network using one or more losses, at least one of the one or more losses taking into account a differences between the multiple input vectors and the respectively associated multiple output vectors. The multiple input vectors at least include non-clean-speech audio waveforms.

It is to be understood that the features mentioned above and those yet to be explained below may be used not only in the respective combinations indicated, but also in other combinations or in isolation without departing from the scope of the disclosure. For illustration, above techniques with respect to the inference of an encoder neural network that has been pre-trained have been disclosed. Techniques have been disclosed in which the encoder neural network is inferred and subsequently, based on an output of the encoder neural network, the audio quality of the input audio waveform input to the encoder neural network is estimated. Such techniques at inference can be combined with techniques disclosed above in connection with the training of an audio quality estimation module. For instance, techniques that have been discussed in connection with the training can be used to train the encoder neural network that is subsequently used for audio quality estimation.

### BRIEF DESCRIPTION OF THE DRAWINGS

FIG. 1 schematically illustrates a use case employing encoder-side audio quality estimation according to various examples.

FIG. 2 schematically illustrates a use case employing decoder-side audio quality estimation.

FIG. 3 schematically illustrates a use case employing audio quality estimation.

FIG. 4 schematically illustrates a neural audio quality estimation module according to various examples.

FIG. 5 schematically illustrates a processing flow of non-intrusively calculating frame-specific quality factors using the neural audio quality estimation module according to FIG. 4.

FIG. 6 schematically illustrates a processing flow of intrusively calculating frame-specific quality factors using the neural audio quality estimation module according to FIG. 4.

FIG. 7 is a flowchart of a method according to various examples.

FIG. 8 schematically illustrates a apparatus according to various examples.

FIG. 9 is a flowchart of a method according to various examples.

### DETAILED DESCRIPTION OF THE INVENTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), a tensor processing unit (TPU), integrated circuits such as application-specific integrated circuits or field-programmable gate array (FPGA) circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the disclosure will be described in detail with reference to the accompanying drawings. It is to be understood that the following description of embodiments is not to be taken in a limiting sense. The scope of the disclosure is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques of estimating the quality of an input audio waveform are disclosed. According to the disclosed techniques, one or more quality factors are determined, wherein these one or more quality factors are indicative of the audio quality of the input audio waveform. For instance, a higher value of a quality factor can indicate a higher audio quality, and vice versa. Hereinafter, techniques of an audio quality estimation module providing such functionality are disclosed.

As a general rule, in the various disclosed techniques, the audio quality estimation module may provide a quality factor for each of multiple frames of a respective input audio waveform. This is sometimes referred to as an online quality factor. The online quality factor is then generally varying from frame to frame.

According to the disclosed techniques, one or more online audio quality factors can be provided in real-time or quasi-real-time. This means that a delay between inputting a respective frame of the input audio waveform into the audio quality estimation module and the respective output, i.e., one or more quality factors, is smaller than, e.g., 50 milliseconds or even smaller than 20 milliseconds, e.g., on consumer-grade portable devices such as smartphones or streaming consoles.

In some examples, the quality estimation module may also provide an offline quality factor that is determined for a collection of multiple frames. For instance, an aggregate quality factor may be determined by aggregating multiple online quality factors determined for individual frames.

As a further general rule, in the various disclosed techniques, the quality estimation model may provide an (offline or online) quality factor blindly—i.e., without access to a reference audio waveform (non-intrusive quality factor)—or with respect to a reference audio waveform (intrusive quality factor). In the latter case, one or more comparisons between values determined for the input audio waveform and the reference audio waveform, respectively, may be executed to obtain the quality factor. Thus, the reference audio waveform serves as a benchmark for the audio quality estimation of the input audio waveform. For example, the amount of audio quality degradation of the input audio waveform vis-à-vis the reference audio waveform can be estimated.

The various options for audio quality estimation according to the disclosed techniques as explained above are summarized in TAB. 1.

TABLE 1
Various options for audio quality estimation in
accordance with the techniques disclosed herein.

| | |
|---|---|
| Online audio quality | A quality factor is determined for each frame of a sequence |
| estimation | of frames. Can be combined with either non-intrusive audio |
| | quality estimation or intrusive audio quality estimation. |
| Off-line audio quality | A quality factor is determined for a collection of frames, e.g., |
| estimation | all frames that make up an entire audio waveform. Can be |
| | combined with either non-intrusive audio quality estimation or |
| | intrusive audio quality estimation. |
| Non-intrusive audio | A quality factor is determined for an input audio waveform |
| quality estimation | without reference to a reference audio waveform. Can be |
| | combined with either online audio quality estimation or off-line |
| | audio quality estimation. |
| Intrusive audio | A quality factor is determined for an input audio waveform by |
| quality estimation | taking into account a reference audio waveform. Can be |
| | combined with either online audio quality estimation or off-line |
| | audio quality estimation. |

Audio quality estimation is helpful in various use cases and application scenarios. Some of these are discussed below.

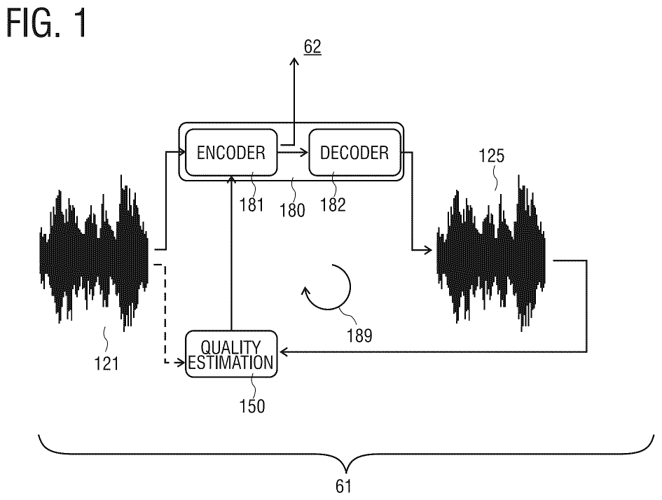

A first use case is illustrated in FIG. 1. Here, an audio codec 180 is executed at a transmitter device 61. The audio codec 180 includes an encoder 181 and a decoder 182, both being executed at the transmitter device 61.

As illustrated in FIG. 1, a compressed representation of a reference audio waveform 121 obtained from the encoder 181 can be provided to a receiver device 62. The receiver device 62 (not shown in FIG. 1) may execute the decoder 182 to reconstruct a reconstructed audio waveform. Then, playback based on the reconstructed audio waveform 125 is possible. Alternatively or additionally, the receiver device 62 may act as a storage for the compressed representation of the reference audio waveform 121, e.g., as a streaming database.

For instance, the receiver device 62 may be a user device, e.g., a streaming client, a smart phone, a smart TV, etc. Oftentimes, the receiver device 62 may have computational resources available that are significantly smaller than the computational resources of the transmitter device 61 which may be, e.g., a server.

Example audio codecs 180 include but are not limited to: SoundStream (see Zeghidour, Neil, et al. “Soundstream: An end-to-end neural audio codec.” IEEE/ACM Transactions on Audio, Speech, and Language Processing 30 (2021): 495-507); Opus (see Valin, Jean-Marc, Koen Vos, and Timothy Terriberry. Definition of the opus audio codec. No. rfc6716. 2012); EVS (see Dietz, Martin, et al. “Overview of the EVS codec architecture.” 2015 IEEE International Conference on Acoustics, Speech and Signal Processing (ICASSP). IEEE, 2015).

In the scenario of FIG. 1, the reference audio waveform 121 is fed to the encoder 181 of the audio codec 180. The encoder 181 determines a compressed representation of the reference audio waveform 121; this compressed representation of the reference audio waveform 121 is then fed to the decoder 182 that outputs a reconstructed audio waveform 125. In the illustrated example, this reconstructed audio waveform 125 is fed back to the quality estimation module 150 in order to determine a quality factor indicative of an audio quality of the reconstructed audio waveform 125. As will be understood, the reconstructed audio waveform 125 output from the decoder 182 of the audio codec 180 thus serves as an input audio waveform to the quality estimation module 150; thus, the audio waveform 125 will be referred to as input audio waveform 125 below.

For instance, an online quality estimation (cf. TAB. 1) may be executed. For an online quality estimation, a sequence of quality factors is obtained, one quality factor for each frame of the audio waveforms 121, 125. For an off-line quality estimation, a single quality factor may be determined for the entire audio waveforms 121, 125. Further, as indicated by the dashed arrow, the quality factor may be determined intrusively or non-intrusively (cf. TAB. 1): for an intrusive audio quality estimation, the reference audio waveform 121 is used as a reference for benchmarking the audio quality of the input audio waveform 125.

Based on one more quality factors that are determined by the audio quality estimation module 150, it is then possible to adjust a configuration of the encoder 181. For instance, the configuration of the encoder 181 can be adjusted to thereby improve the playback quality reconstructed audio waveforms obtained from the audio codec 180. A feedback loop 189 can be implemented. The feedback loop 189 can have a latency of only a single frame or only a few frames, for online quality estimation. As illustrated in FIG. 1, the compressed representation of the reference audio waveform 121 can be provided to the receiver device 62, e.g., a receiver device via the Internet. By means of that feedback loop 189, the playback quality based on the compressed representation or more generally audio data that has been compressed using the encoder 181 can be increased.

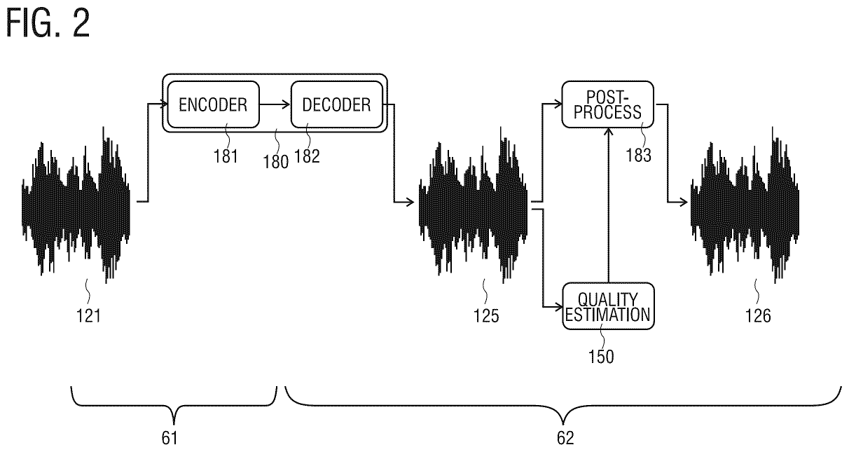

Another use case is illustrated in FIG. 2. FIG. 2 illustrates a scenario in which the audio codec 180 is employed to transmit a compressed representation of the reference audio waveform 121 from the transmitter device 61 to the receiver device 62. The encoder 181 is executed at the transmitter device 61 while the decoder 182 is executed at the receiver device 62.

In the scenario of FIG. 2, the quality estimation module 150 is executed at the receiver device 62 and again used to determine a quality factor indicative of the quality of the input audio waveform 125—i.e., the output of the decoder 182, as previously discussed in connection with FIG. 1—obtained from the audio codec 180.

An intrusive or non-intrusive audio quality estimation is possible; an online or off-line audio quality estimation is possible (cf. TAB. 1). Typically, a non-intrusive audio quality estimation (cf. TAB. 1) may be preferred in the scenario FIG. 2, because access to the reference audio waveform 121 may be limited at the receiver device 62.

In the scenario FIG. 2, the quality factor determined by the quality estimation module 150 is used to set a configuration of an audio postprocessing module 183 that postprocesses the input audio waveform 125, to thereby obtain a post-processed input audio waveform 126. The post-processing module 183 may provide equalization or a machine-learned audio augmentation.

Here, an online audio quality estimation (cf. TAB. 1) may be preferred that provides a sequence of quality factors for each frame decoded by the decoder 182, preferably at a relatively short latency. The latency may be as small as a single frame so that if a certain audio quality is detected for a frame n, the postprocessing of the frame n+2 can be adjusted. Using the techniques disclosed herein, computationally inexpensive quality estimation becomes possible so that also at devices having limited computational resources—which is typically the case for streaming clients, e.g., smart phones or smart TVs—low-latency quality estimation becomes possible.

For instance, if an impaired quality of the input audio waveform 125 is detected, the postprocessing module 183 may be configured—e.g., in (quasi-)real-time—in order to compensate for that impaired quality, so that the audio playback quality is improved.

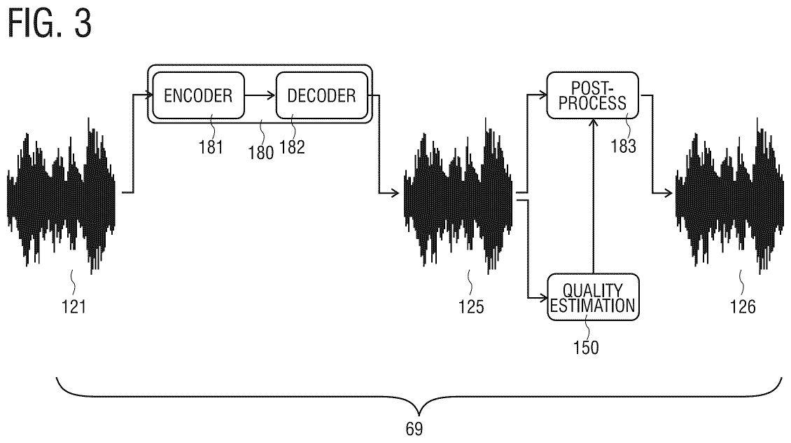

FIG. 3 generally corresponds to FIG. 2; however, all calculations are executed in a single device 69. The encoded audio data may be stored locally in the compressed format.

As will be appreciated from the discussion of FIG. 1, FIG. 2, and FIG. 3 above, the quality estimation module 150 according to the disclosed techniques is particularly versatile in that it can be deployed both at servers as well as client devices. This is because the quality estimation module 150 can provide a quality estimation at comparatively limited computational resources so that, e.g., for an online quality estimation a latency to obtain a quality factor for a given audio frame is short even for devices having limited computational resources. Furthermore, the quality estimation module 150 is also capable of providing a non-intrusive audio quality estimation, which makes it suitable for receiver-side quality estimation without access to the non-impaired audio waveform. These and further benefits of the audio quality estimation module 150 will become apparent from the detailed discussion of its algorithmic implementation provided below.

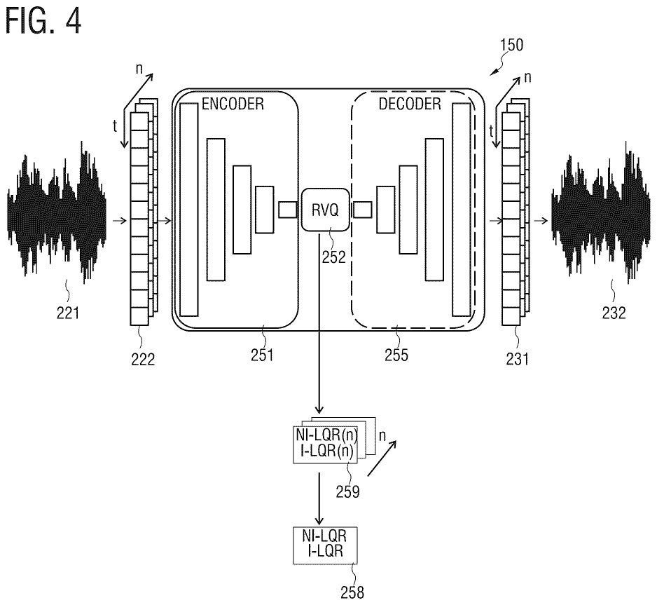

FIG. 4 illustrates an example implementation of the audio quality estimation module 150. The quality estimation module 150 is a machine-learned audio quality estimation module 150, specifically a neural audio quality estimation module. Thus, it includes one or more weights/parameters that have been set in a training process, e.g., using gradient descent optimization in a backpropagation training process. In particular, the quality estimation module 150 is a neural quality estimation module that is based on a deep neural network architecture. The deep neural network architecture includes multiple layers stacked one after another that are jointly trained in a training process.

The audio quality estimation module 150 may not only be suitable for audio quality estimation; the audio quality estimation module 150 may rather also be capable for encoding/decoding of input audio waveforms. In other words, the audio quality estimation module 150 may include modules that have been trained on a relatively broad training dataset that includes not only high-quality audio waveforms but also audio waveforms of reduced quality. For example, the training data set used to train the various modules of the audio quality estimation module 150 may include clean-speech audio waveforms as well as non-clean speech audio waveforms. This enables the audio quality estimation module 150 to encode and subsequently decode audio waveforms across a relatively wide spectrum of qualities. Thus, briefly, the modules discussed below may be used for audio quality estimation and as a neural audio codec, according to the choice of the user. In further detail, the quality estimation module 150 includes an encoder 251 and a vector quantizer, specifically, in the illustrated example, a residual vector quantizer (RVQ) 252. As shown in FIG. 4, one or more quality factors 259 are determined based on the processing at the RVQ 252. For instance, multiple on-line quality factors 259 may be determined, on for each frame. These quality factors can be aggregated to an off-line quality factor 258.

The encoder 251 includes multiple stacked layers. For instance, the encoder 251 may include multiple convolutional layers. The encoder 251 may include skip connection. The encoder 251 may include one or more multi-headed self-attention layers.

The weights of the layers of the encoder 251 as well as weights of the RVQ 252 are machine learned, i.e., set in a machine-learning training process. Unsupervised learning is possible by using, at training time, a decoder 255 that reconstructs the input audio waveform 221; the respective output audio waveform 232 is then compared with the input audio waveform 221 to determine a respective reconstruction loss to adjust the weights of the encoder 251 and the decoder 255. Furthermore, to allow for flexible and accurate representation of the input audio waveform 221, the codebooks of the quantization layer may be optimized to minimize the quantization error introduced to the encoder output. Specifically, an end-to-end training may be used in which the weights of the encoder 251, the RVQ 252, and the decoder 255 are jointly adjusted, i.e., based on one or more common loss functions and using joint gradient-descent optimization facilitated by backpropagation. The decoder 255, on the other hand, is not used during inference time when estimating the quality of input audio waveforms 221, e.g., in one of the use cases discussed above in connection with FIG. 1, FIG. 2, and FIG. 3. This is why the decoder 255 is shown using dashed lines in FIG. 1. The decoder 255 is a tool for training the encoder 251 and the RVQ 252. Note however that the encoder 251, RVQ 252, and the decoder 255 may also be used to implement a neural audio codec; in such case the decoder 255 may be used for decompressing the compressed representation of the input audio waveform 221. Thus, as will be appreciated, the encoder 251 and the RVQ 252 can be used for audio quality estimation as well as for compression.

As shown in FIG. 4, each signal frame s of the input audio waveform 221 can be represented as an input vector 222 including multiple audio samples along time dimension t. The input audio waveform 221 is then represented by a sequence of input vectors 222 for the sequence of signal frames s(n), n=1 . . . . N. Each input vector 222 is processed individually in the encoder 251, to determine a respective latent representation of the respective feature vector.

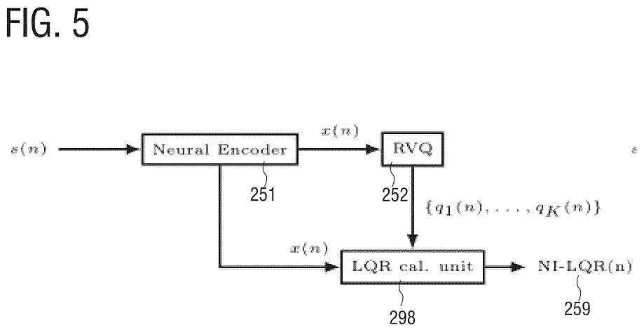

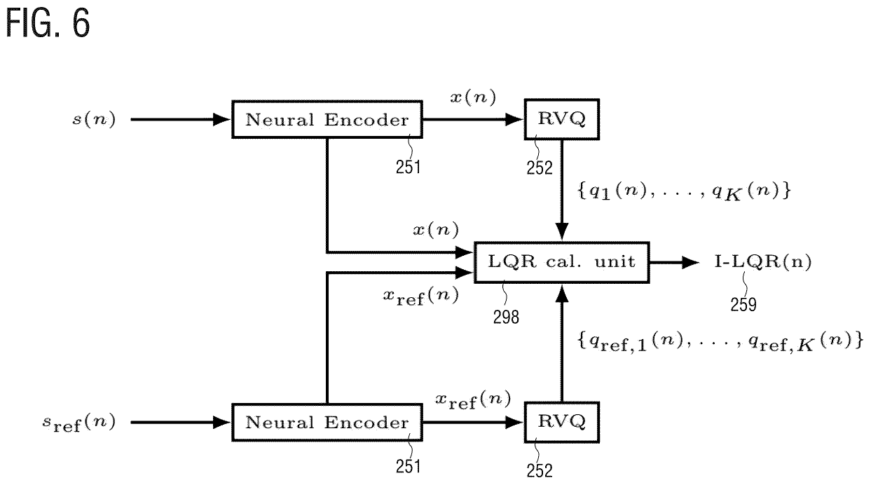

Next, two options for determining the quality factors 258, 259 are discussed. These two options are comparable in that similar metrics are used for judging the audio quality. The option in FIG. 5 pertains to a non-intrusive calculation of the audio quality factors 258, 259; while the option in FIG. 6 pertains to an intrusive calculation of the audio quality factors 258, 259 (cf. TAB. 1).

As shown in FIG. 5, a signal frame (including a certain number of audio samples) is processed in the encoder 251:

$$x ( n ) = Encoder ( s ( n ) ) . \qquad ( 1 )$$

x(n) is the latent representation of the signal vector s(n).

The term “frame” may refer to a segment of an audio waveform that includes one or more audio samples. In some examples, a frame may be a fixed-size block of consecutive audio samples, while in other cases, a frame may be a variable-size block of audio samples that are grouped together based on certain criteria, such as a specific time duration or a specific number of samples. The size of a frame may vary depending on the specific application and requirements.

The term “sample” may refer to a single value representing the amplitude of an audio waveform at a particular point in time. In digital audio processing, samples are typically represented by a fixed number of bits, such as 16-bit or 32-bit integers, which provide a quantized representation of the continuous audio signal. The sampling rate of an audio waveform may determine the frequency resolution and fidelity of the audio signal, with higher sampling rates generally providing more accurate representations of the original audio signal.

To produce a discrete coded representation, the latent representation of a signal frame obtained from the encoder, i.e., the latent feature vector, is then quantized iteratively by employing the RVQ 252, where the k-th quantization step:

$${q}_{k} ( n ) = {VQ}_{k} ( x ( n ) - {\sum }_{i = 0}^{k - 1} {q}_{i} ( n ) ) ; {q}_{0} = 0 , \qquad ( 2 )$$

Here, VQ denotes the vector quantization operator, e.g., as described in Van Den Oord, Aaron, and Oriol Vinyals. “Neural discrete representation learning.” Advances in neural information processing systems 30 (2017).

qₖ denotes the output of the k-th vector quantizer.

The RVQ employs multiple quantization stages indexed by k, wherein each quantization stage refines the quantization residue produced by the previous quantization stage. At quantization stagek, a codebook Cₖ is accessed to map the current residual vector rₖ to a quantized representative qₖ chosen from a finite set of entries. The quantized vector for quantization stage k is then subtracted from rₖ to generate a new residual vector rₖ₊₁, which is passed to the subsequent quantization stage k+1. Each codebook Cₖ is optimized during the training process to capture the statistical or structural properties of the residual vectors associated with that quantization stage, thereby progressively improving the overall quantization accuracy. The RVQ allows for a flexible quantization depth K, as the number of quantization stages may be selected based on factors such as desired bit rate or target fidelity. Consequently, RVQ yields a hierarchical approach: initial quantization stages handle coarse quantization, while later quantization stages provide finer detail by quantizing only the remaining residuals. By leveraging distinct codebooks at each quantization stage, the RVQ efficiently encodes complex feature vectors with minimal reconstruction error, thereby providing a robust and scalable quantization representation.

The quantized representation may be used, e.g., by concatenating the K quantized tensores to reconstruct the input signal s such that

$$\hat{s} = Decoder ( {q}_{1} ( n ) , … , {q}_{k} ( n ) ) \qquad ( 3 )$$

This is the task of the decoder 255 (cf. FIG. 4); the decoder 255 is, however, not required to determine the audio quality estimate. Rather, the audio quality estimation is based on the quantization error of the RVQ 252; thus, the module 298 for calculating the quality factors obtains the quantization, as shown in FIG. 5.

The quantization error resulting from Eq. (2) for the k-th quantization stage is obtained by

$${e}_{k} ( n ) = x ( n ) - {\sum }_{i = 1}^{k} {q}_{i} ( n ) . \qquad ( 4 )$$

To recap: this is the error of the quantization applied to latent representation of the input vector 222.

Various techniques are based on the finding that the quantization error—e.g., aggregated across multiple quantization stages—is a proxy for the quality of the encoded signal. For example, input audio waveforms of lower quality typically result in a larger quantization error. This is seen as a consequence of the end-to-end training of the encoder 251, RVQ 252, and decoder 255 which are optimized for lower quantization errors and higher reconstruction quality. Motivated by this finding, according to various examples, one or more indicators indicative of the quantization error of a respective latent representation of the input vector (also referred to as feature vector or embedded feature vector) are used to determine a quality factor for that input vector.

In detail, consider the following on-line frame-by-frame quality factor NI-LQR(n) determined for a certain frame s(n) which is based on a sum of indicators associated with the quantization error at each quantization stage:

$$NI - LQR ( n ) = \frac{1}{K} {\sum }_{k = 1}^{K} NI - {LQR}_{k} ( n ) . \qquad ( 5 )$$

As will be appreciated, the quality factor calculated for the respective feature vector representing a certain frame is based on multiple indicators NI-LQRₖ(n) associated with the multiple quantization stages k. These indicators associated with the individual quantization stages are then aggregated as in Eq. (5), to obtain the overall indicator of the quantization error of the given feature vector.

$${\sum }_{k = 1}^{K} NI - {LQR}_{k} ( n )$$

may be seen as an indicator indicative of the overall quantization error of the RVQ 252.

Note that this is only one option. In another scenario, it would be possible that the overall quantization error of the RVQ 252 is determined solely based on the quantization error of the first quantization stage or the last quantization stage. Then, an aggregation as in Eq. (5) would not be required, further speeding up the calculations.

In NI-LQR, NI stands for “non-intrusive”; which is the particular type of quality factor determined in FIG. 5.

In NI-LQR, LQR stands for latent-representation-to-quantization-error power-ratio: Various techniques are based on the finding that while the quantization error of the vector quantization operation is a proxy of the audio quality of the input audio waveform 221, it is beneficial to normalize the quantization error. This is because the quantization error is not only impacted by the quality of the input audio waveform 221 but also by the signal power of the vector that undergoes quantization, i.e., the vector to which the vector quantization operation is applied. In the present case, this is the latent representation x(n) of the input vector 221. Thus, in order to enable a more reliable audio quality estimation also across a wide dynamic range of the input audio waveform 221, the quantization error, according to examples, is normalized. This is explained next for various examples.

There are various options of implementing this function NI-LQRₖ(n) and one relatively simple option is presented below:

$$NI - {LQR}_{k} ( n ) = \frac{σ ( x ( n ) )}{σ ( {e}_{k} ( n ) )} , \qquad ( 6 )$$

Here, the quantization error at quantization stage k is normalized to the latent representation of the input vector x(n). More specifically, σ(eₖ(n)) describes the variance of the quantization error eₖ(n) at a respective quantization stage of the RVQ 252 calculated over the features dimensions. σ is the variance operator across feature dimension. In this example, the variance of the quantization error at each quantization stage is normalized to the variance of the latent representation of the feature vector, i.e., the input to the first of multiple quantization stages. A single normalization value is used. This is an efficient and relatively accurate measure of the audio signal quality since quantization errors across all quantization stages are expected to increase for larger variances of the feature vector.

Another option for implementing NI-LQRₖ(n) is:

$$NI - {LQR}_{k} ( n ) = \frac{σ ( {e}_{{k}^{′}} ( n ) )}{σ ( {e}_{k} ( n ) )} , \qquad ( 7 )$$

where k′ may be defined, e.g., as k′=k−1 and e₀:=x. σ(eₖ(n)) denotes a function of the quantization error eₖ(n) of the k-th quantization stage calculated per frame over the features dimension. As will be appreciated from Eq. (7), the indicator σ(eₖ(n)) indicative of the quantization error of a given quantization stage used to calculate the quality factor NI-LQR (n) is not taken as an absolute value but in relationship to the respective indicator σ(eₖ,(n))—i.e., the variance of the quantization error of the next higher quantization stage. Note that the quantization error of the next higher quantization stage is the residue input to the given quantization stage. This indicator σ(eₖ,(n)) of the quantization error of the next higher quantization stage can thus be seen as a normalization value to the indicator indicative of the quantization error at the given quantization stage. Multiple such normalization values are used, different ones for different quantization stages. These normalization values set the quantization error at a given quantization stage into relationship with properties of the vector input to that same quantization stage of the vector quantizer (different to, e.g., Eq. (6)). This has been found to enable reliable audio quality assessment for a wide range of audio qualities, i.e., for degraded to high-quality input audio waveforms.

Note that this is only one option and various modifications are within the scope of the disclosure. For instance, the metric to map the quantization error to the quality factor may be different. Fore example, a variant to Eq. (7) would be to use the Euclidean norm (L2-norm) instead of the variance, for the normalization value as well as the indicator indicative of the quantization error:

$$NI - {LQR}_{k} ( n ) = \frac{{‖ {e}_{{k}^{′}} ( n ) ‖}_{2}^{2}}{{‖ {e}_{k} ( n ) ‖}_{2}^{2}} . \qquad ( 8 )$$

Also Eq. (6) can be re-formulated using the Euclidean norm:

$$NI - {LQR}_{k} ( n ) = \frac{{‖ x ( n ) ‖}_{2}^{2}}{{‖ {e}_{k} ( n ) ‖}_{2}^{2}} . \qquad ( 9 )$$

An offline audio quality estimation may be obtained by averaging- or more generally aggregating-over all signal frames rendering NI-LQR as (also cf. FIG. 4):

$$NI - LQR = {\sum }_{n = 1}^{N} {β}_{n} NI - LQR ( n ) , \qquad ( 10 )$$

where Bn is a weight which may either be constant, e.g., βₙ=1/N, or calculated according to the input audio waveform characteristic, e.g., depending on the speech presence probability.

Above, in connection with FIG. 5, a non-intrusive audio quality estimation has been disclosed. Next, in connection with FIG. 6, and intrusive audio quality estimation is discussed. Specifically, LQR can also be used intrusively (cf. TAB. 1) to evaluate the quality of the input audio waveform s by comparing it (in the embedding domain) to a clean reference input audio waveform s_{ref}(n). More specifically, given a degraded signal frame s and a reference signal frame s_{ref}(n), corresponding embedding vectors are obtained as

$$x ( n ) = Encoder ( s ( n ) ) . \qquad ( 11 )$$

$${x}_{ref} ( n ) = Encoder ( {s}_{ref} ( n ) ) . \qquad ( 12 )$$

Similarly, a quantized representation is calculated by:

$${q}_{k} ( n ) = {VQ}_{k} ( x ( n ) - {\sum }_{i = 0}^{k - 1} {q}_{i} ( n ) ) ; {q}_{0} = 0 , \qquad ( 13 )$$

$$and$$

$${q}_{ref , k} ( n ) = {VQ}_{k} ( {x}_{ref} ( n ) - {\sum }_{i = 0}^{k - 1} {q}_{i} ( n ) ) ; {q}_{0} = 0 , \qquad ( 14 )$$

respectively.

Hence, the quantization errors associated with the input audio waveform and the reference audio waveform are:

$${e}_{k} ( n ) = x ( n ) - {\sum }_{i = 1}^{k} {q}_{i} ( n ) . \qquad ( 15 )$$

$$and$$

$${e}_{ref , k} ( n ) = {x}_{ref} ( n ) - {\sum }_{i = 1}^{k} {q}_{ref , i} ( n ) . \qquad ( 16 )$$

To compare the degraded signal to the reference, I-LQR may be defines as:

$$I - {LQR}_{k} ( n ) = \frac{{‖ {x}_{ref} ( n ) ‖}_{2}^{2}}{{‖ {e}_{ref , k} ( n ) ‖}_{2}^{2}} - \frac{{‖ x ( n ) ‖}_{2}^{2}}{{‖ {e}_{k} ( n ) ‖}_{2}^{2}} , \qquad ( 17 )$$

where

$${‖ \cdot ‖}_{2}^{2} \qquad ( 17 )$$

denotes the L2-norm operator (Euclidean norm) over the feature's dimension, as in Eqs. (8) and (9). As discussed above, the variance may be used instead.

$$I - {LQR}_{k} ( n ) = \frac{σ ( {x}_{ref} ( n ) )}{σ ( {e}_{ref , k} ( n ) )} - \frac{σ ( x ( n ) )}{σ ( {e}_{k} ( n ) )} , \qquad ( 18 )$$

Other metrics beyond L2 and variance are possible. To take into account the contributions of individual quantization stages, the average over quantizer is taken, i.e.,

$$I - LQR ( n ) = \frac{1}{K} {\sum }_{i = 1}^{K} \vert I - {LQR}_{i} ( n ) \vert , \qquad ( 19 )$$

where |·| denotes the absolute value operation. Eq. (19) produces one quality factor per frame; an offline signal-level variant can be calculated by aggregating:

$$I - LQR = {\sum }_{n = 1}^{N} {β}_{n} I - LQR ( n ) \qquad ( 20 )$$

where βₙ is a weight which may either be constant, e.g., βₙ=1/N, or calculated according to the input audio waveform characteristic, e.g., depending on the speech presence probability.

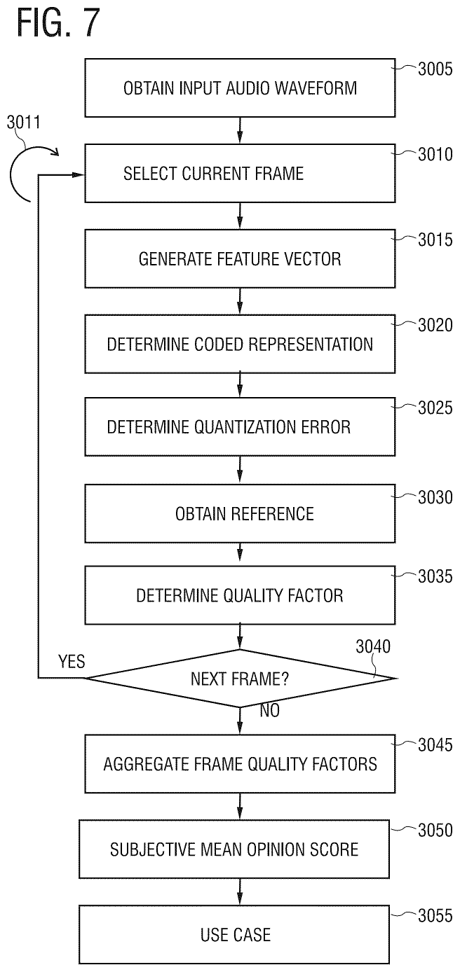

FIG. 7 is a flowchart of a method according to various examples. The method of FIG. 7 may be executed by a computing device. The method of FIG. 7 may be executed by a processor, upon loading program code from a memory and upon executing the program code. The method of FIG. 7 generally pertains to audio quality estimation. The method of FIG. 7 may employ the quality estimation module 150 as previously discussed in connection with FIG. 4, FIG. 5, and FIG. 6.

At box 3005, the input audio waveform 221 is obtained. Input vectors 222 are constructed for each frame. The elements of the input vectors 222 include the audio samples.

At box 3010, a current frame is selected for processing in the quality estimation module 150. This selection at box 3010 defines multiple iterations 3011. The frames can be selected as they become available in a streaming buffer.

At box 3015, the latent representation of the respective input vector 222 associated with that current frame is calculated, in the encoder 251 See, e.g., Eq. (1) and Eq. (11). An embedded feature vector is thereby obtained.

At box 3020, the embedded feature vector is subjected to a vector quantization operation, to obtain a respective encoded representation. See, e.g., Eq. (2) and Eq. (13). An RVQ may be used.

At box 3025, one or more indicators associated with a quantization error of the quantization operation are determined. For example, multiple indicators associated with the quantization errors at multiple stages of a multi-stage quantization operation such as the RVQ can be determined—cf. Eqs. (6), (7), (8), (9), (17), (18).

At optional box 3030 (cf. FIG. 6), one or more references may be obtained for a reference audio waveform. The reference can be similarly calculated as the calculations and box 3025. Specifically, these one or more references may be associated with one or more relationships between respective one or more indicators of quantization errors for the reference audio waveform and respective normalization values and can be compared against such one or more relationships calculated for the input audio waveform; this has been previously discussed by the subtraction in Eqs. (17) and (18).

At box 3035, a respective frame-specific online quality factor is determined for the current frame of the current iteration 3011. For instance, this may be simply a given one of the one or more indicators of box 3025, e.g., after comparison at box 3030. if there are multiple indicators for the quantization error, these multiple indicators may be summed, averaged, or otherwise combined—cf. Eqs. (5), (19).

At box 3040, it is checked whether there is a next frame to be processed, e.g., because it has become available in a streaming buffer. If this is the case, then a further iteration 3011 of box 3010 is executed.

If all frames have been processed, the method commences at box 3045, where it is optionally possible to aggregate the frame-specific online quality factors of the multiple iterations 3011 of box 3035 to obtain an aggregate off-line quality factor, cf. Eqs. (10) and (20).

Optionally, at box 3050, each of the frame-specific quality factors of the multiple iterations 3011 of box 3035 and/or an aggregate quality factor obtained from box 3045 may be met to a subjective quality score MOS. For instance, a linear mapping may be used:

$$MOS = α \cdot LQR ( n ) + η \qquad ( 21 )$$

where α and η denote trainable parameters for scaling and bias correction, respectively.

A non-linear mapping is also possible where, e.g., a deep neural network f is trained to map one or more LQRs calculated according to one or more of the variants above to the MOS:

$$MOS = f ( {LQR}_{1} ( n ) , … , {LQR}_{z} ( n ) ) . \qquad ( 22 )$$

As will be appreciated, the deep neural network may aggregate multiple LQRs determined for a sequence of frames to determine an aggregate subjective quality factor MOS. The deep neural network may be trained using a training dataset that includes respective audio waveforms and ground truth for the subjective quality factor. Then, after training the encoder neural network and the RVQ, the LQRs can be determined as outlined above and training of the deep neural network f can commence.

While above a scenario has been explained in which the deep neural network operates of the sequence of frame-specific LQRs, it would be similarly possible that the deep neural network operates based on an aggregate quality factor, e.g., as obtained from box 3045.

At box 3055, the output of, e.g., multiple iterations 3011 of box 3035, the output of box 3045, and/or the output of 3050 can be used in one or use cases. For instance, some use cases have been previously explained in connection with FIG. 1, FIG. 2, and FIG. 3.

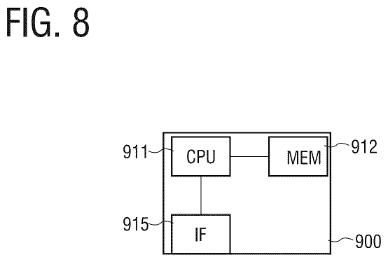

FIG. 8 schematically illustrates a apparatus 900 (which may also be referred to as processing device) including a processor 911 and the memory 912. The apparatus 900 also includes a communication interface 915. The processor 911 can obtain audio data via the communication interface 915, e.g., audio waveforms. The processor 911, upon loading program code from the memory 912 and upon executing the program code, can perform techniques as disclosed herein, e.g., in connection with FIG. 7.

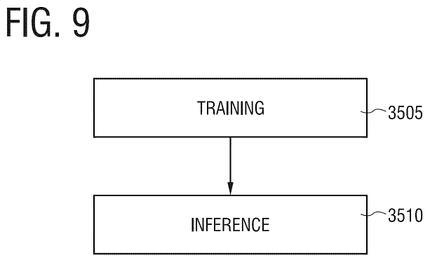

FIG. 9 is a flowchart of a method according to various examples. The method of FIG. 9 may be executed by an apparatus. For example, the method of FIG. 9 may be executed by the apparatus 900 previously discussed in connection with FIG. 8. The method of FIG. 9 may be executed by a processor, upon loading program code from a memory and upon executing the program code. The method of FIG. 9 pertains to training and inferring a machine-learning module such as the neural audio quality estimation module 150 discussed above.

At box 3505, the machine-learning module is trained. The machine-learning module has an autoencoder-type setup with a vector quantizer at the bottleneck between encoder and decoder (cf. FIG. 4).

Unsupervised learning based on a reconstruction loss may be used. Thus, multiple input vectors are obtained from a training dataset. These input vectors represent audio waveforms.

The training dataset may include arbitrary audio waveforms. This is enabled by the versatility of the normalized quantization error discussed above.

Specifically, the training data set may include audio waveforms that represent clean speech as well as audio waveforms that represent non-clean speech. The training data set may include music audio waveforms, etc.

Then, weights of the machine-learning module are adjusted based on one or losses. The at least one loss may be a reconstruction loss that is based on a difference between the input vectors and the output vectors obtained from the neural decoder. A distance between the reconstructed output obtained from the neural decoder in the input to the neural encode a can be calculated and minimized by respective optimization techniques. End-to-end training of the components of the machine-learning module can be performed.

At box 3510, the machine-learning module is inferred. The machine-learning module may be used for audio quality estimation, e.g., as discussed in connection with FIG. 6. Alternatively or additionally, the machine learning module may also be used as a neural audio codec.

The machine learning module is capable of acting, both, as a quality estimator as well as a neural audio codec, because it has been trained using a training dataset that includes audio waveforms across a wide variety of qualities that are also encountered at normal encoder tasks.

Summarizing, techniques have been disclosed above that enable accurate and low-latency audio quality estimation. Specific training strategies are not required to produce a latent representation of an input vector. Rather, generic trained neural codecs can be used in an out-of-the-box manner. Frame-by-frame online calculation of an audio quality factor is enabled. Off-line distance measurements are not required, but possible. A signal-to-quantization error power ratio is used, thereby enabling him herein normalization of the quantization error to the input signal level. This enables more accurate calculation of the audio quality, across a wide dynamic range of audio. The fine-tuning or specific training strategies, e.g., using triplet loss, are not required.

Although the disclosure has been shown and described with respect to certain preferred embodiments, equivalents and modifications will occur to others skilled in the art upon the reading and understanding of the specification. The present disclosure includes all such equivalents and modifications and is limited only by the scope of the appended claims.

For illustration, various scenarios have been discussed in connection with a RVQ including multiple quantization stages. The techniques disclosed herein can also be applied in connection with other forms of vector quantization operation.

What is claimed is:

1. A method performed by one or more apparatuses, the method comprising:
obtaining an input audio waveform that comprises a sequence of audio samples,
using a pre-trained encoder neural network to generate, based on the input audio waveform, a sequence of feature vectors representing the sequence of audio samples using multiple features,
for each feature vector of the sequence of feature vectors: determining a respective coded representation of the respective feature vector using vector quantization and further determining one or more indicators indicative of a respective quantization error associated with the respective coded representation of the respective feature vector,
for each feature vector of the sequence of feature vectors: determining a respective quality factor based on one or more relationships between the one or more indicators indicative of the respective quantization error and one or more respective normalization values.

2. The method of claim 1,
wherein the respective one or more normalization values associated with a given feature vector are based on at least one respective input vector to one or more quantization stages of the vector quantization.

3. The method of claim 2,
wherein the vector quantization is a residual vector quantization comprising two or more quantization stages,
wherein the respective one or more normalization values associated with a given feature vector of the sequence of feature vectors are based at least on an input to a first one of the two or more quantization stages.

4. The method of claim 3,
wherein the respective one or more normalization values associated with a given feature vector of the sequence of feature vectors comprise a single normalization value associated with multiple of the two or more quantization stages.

5. The method of claim 2,
wherein the vector quantization is a residual vector quantization comprising two or more quantization stages,
wherein the respective one or more normalization values associated with a given feature vector of the sequence of feature vectors comprises multiple normalization values associated with different ones of the two or more quantization stages.

6. The method of claim 2,
wherein each of the one or more normalization values associated with a given feature vector of the sequence of feature vectors is calculated as a variance across a feature dimension of the at least one respective input vector.

7. The method of claim 2,
wherein each of the one or more normalization values associated with a given feature vector of the sequence of feature vectors is calculated as a Euclidean norm across a feature dimension of the at least one respective input vector.

8. The method of claim 1,
wherein the vector quantization is a residual vector quantization comprising two or more quantization stages,
wherein the one or more indicators indicative of a respective quantization error of each feature vector of the sequence of feature vectors is based on multiple indicators associated with different ones of the two or more quantization stages.

9. The method of claim 8, further comprising:
for each feature vector of the sequence of feature vectors: aggregating the multiple indicators associated with different ones of the two or more quantization stages.

10. The method of claim 1,
wherein each of the one or more indicators indicative of a respective quantization error of each feature vector of the sequence of feature vectors is calculated as a variance across a feature dimension of a respective quantization error.

11. The method of claim 1,
wherein each of the one or more indicators indicative of a respective quantization error of each feature vector of the sequence of feature vectors is calculated as a Euclidean norm of a respective quantization error vector (eₖ).

12. The method of claim 1, further comprising:
obtaining a reference audio waveform that comprises a sequence (n) of reference audio samples,
using the pre-trained encoder neural network to generate, based on the reference audio waveform, a sequence of reference feature vectors representing the sequence of reference audio samples using the multiple features,
for each reference feature vector of the sequence of reference feature vectors: determining a respective coded representation of the respective reference feature vector using the vector quantization and further determining one or more reference indicators indicative of the respective quantization error associated with the respective coded representation of the respective reference feature vector,
for each reference feature vector of the sequence of reference feature vectors: one or more reference relationships between the one or more reference indicators indicative of the respective quantization error and one or more respective reference normalization values,
wherein the respective quality factor of each feature vector of the sequence of feature vectors is determined based on one or more comparisons between the respective one or more relationships and the one or more reference relationships.

13. The method of claim 1, further comprising:
determining an aggregate quality factor for the input audio waveform based on an aggregation of the quality factors of each feature vector of the sequence of feature vectors to determine an aggregate

14. The method of claim 1, further comprising:
obtaining a reference audio waveform,
compressing and decompressing the reference audio waveform using an audio codec, to thereby obtain the input audio waveform,
based on at least one of the quality factors determined for each feature vector of the sequence of feature vectors, adjusting a configuration of an encoder of the audio codec, to thereby improve playback quality of audio data encoded using the audio codec.

15. The method of claim 1, further comprising:
obtaining a compressed representation of a reference audio waveform,
decompressing the compressed representation of the reference audio waveform using a decoder of an audio codec, to thereby obtain the input audio waveform,
based on at least one of the quality factors determined for each feature vector of the sequence of feature vectors, adjusting a configuration of an audio postprocessing module, to thereby improve playback quality of audio data encoded using the audio codec.

16. The method of claim 1,
wherein at least the encoder neural network is trained using non-clean-speech audio samples.

17. The method of claim 1, further comprising:
using a pre-trained neural network to determine one or more subjective quality factors based on the quality factors determined for each feature vector of the sequence of feature vectors.

18. An apparatus, comprising a processor and a memory, the process of being configured to load program code from the memory and to execute the program code, the processor, upon executing the program code, being configured to:
obtain an input audio waveform that comprises a sequence of audio samples,
use a pre-trained encoder neural network to generate, based on the input audio waveform, a sequence of feature vectors representing the sequence of audio samples using multiple features,
for each feature vector of the sequence of feature vectors: determine a respective coded representation of the respective feature vector using vector quantization and further determine one or more indicators indicative of a respective quantization error associated with the respective coded representation of the respective feature vector,
for each feature vector of the sequence of feature vectors: determine a respective quality factor based on one or more relationships between the one or more indicators indicative of the respective quantization error and one or more respective normalization values.

19. A method of training an audio quality estimation module, the audio quality estimation module comprising an encoder neural network for determining feature vectors based on input vectors, a vector quantizer for determining coded representations of the feature vectors, and a decoder neural network for decoding the coded representations of the feature vectors, thereby obtaining output vectors,
wherein the method comprises:
adjusting weights of the encoder neural network, the vector quantizer, and the decoder neural network using one or more losses, at least one of the one or more losses taking into account a differences between the multiple input vectors and the respectively associated multiple output vectors,
wherein the multiple input vectors at least comprise non-clean-speech audio waveforms.

20. The method of claim 19, further comprising:
using the encoder neural network and the vector quantizer for quality estimation of input audio waveforms.

21. The method of claim 19, further comprising:
employing the encoder neural network, the vector quantizer, and the decoder neural network as a neural audio codec.

22. A deep neural audio quality estimation module comprising a deep neural encoder, a vector quantizer, and a quality calculation module, the quality calculation module estimating the audio quality of an audio signal based on a normalized quantization error of the vector quantizer for the audio signal.

23. The deep neural audio quality estimation module of claim 22, wherein the normalized quantization error is a signal-to-quantization-error power ratio.

24. The deep neural audio quality estimation module of claim 22, wherein the deep neural encoder and the vector quantizer are trained in an end-to-end training process employing an unsupervised reconstruction loss that is based on an output from a deep neural decoder, the end-to-end training process being based on a training dataset that comprises both clean speech as well as non-clean-speech samples.
